(19) United States
(12) Patent Application Publication
(10) Pub. No.: US 2024/0311995 A1
(43) Pub. Date: Sep. 19, 2024

(54) METHOD FOR DETERMINING THE DEPOSITION ACCURACY OF A PLURALITY OF ELECTRODE PLATES IN A STACK, AND MEASURING DEVICE

(71) Applicant: Volkswagen Aktiengesellschaft, Wolfsburg (DE)

(72) Inventors: Steffen MASUCH, Braunschweig (DE); Christian Schroeder, Braunschweig (DE)

(73) Assignee: Volkswagen Aktiengesellschaft, Wolfsburg (DE)

(21) Appl. No.: 18/672,470

(22) Filed: May 23, 2024

Related U.S. Application Data
(63) Continuation of application No. PCT/EP2022/082422, filed on Nov. 18, 2022.

(30) Foreign Application Priority Data
Nov. 23, 2021 (DE) 10 2021 130 653.1

(51) Int. Cl. G06T 7/00; H01M 4/04

(52) U.S. Cl. CPC G06T 7/0006; H01M 4/04; G06T 2207/20081; G06T 2207/20084

(57) ABSTRACT

A method for determining a deposition accuracy of a plurality of electrode sheets, which each comprise at least one anode sheet, one cathode sheet and one separator sheet. The electrode sheets extend in mutually parallel planes and are arranged stacked on top of one another and form a stack. The deposition accuracy describes a respective position of at least boundary edges of one of the electrode sheets in the stack. The method is performed with a measuring device comprising at least a camera and a light source. A measuring device for carrying out the method is also provided.

This nonprovisional application is a continuation of International Application No. PCT/EP2022/082422, which was filed on Nov. 18, 2022, and which claims priority to German Patent Application No. 10 2021 130 653.1, which was filed in Germany on Nov. 23, 2021, and which are both herein incorporated by reference.

### BACKGROUND OF THE INVENTION

### Field of the Invention

The invention relates to a method for determining the deposition accuracy of a plurality of electrode sheets in a stack and to a measuring device. The electrode sheets extend in mutually parallel planes and are arranged stacked on top of one another to form a stack. The deposition accuracy describes the positions of the boundary edges of the electrode sheets in relation to each other in the stack.

### Description of the Background Art

Batteries, especially lithium-ion batteries, are increasingly being used to power motor vehicles. Batteries are usually composed of cells, with each cell having a composite of anode sheets, cathode sheets and possibly separator sheets or separator material. These anode sheets, cathode sheets and possibly separator sheets are referred to below as electrode sheets.

The electrode sheets are usually produced by punching or cutting, e.g. laser cutting.

The deposition accuracy of the individual electrode sheets in a stack has a significant influence on safety-relevant quality criteria of lithium-ion battery cells and on their performance. The electrochemical performance of a battery cell decreases more quickly with less electrode coverage or coverage of the active material during operation. In addition, a short circuit and failure of the battery cell are triggered by direct contact between the anode sheets and cathode sheets. For this reason, the criterion must be checked in the stack and before housing the stack in the housing of the battery cell. The deposition accuracy, i.e. the deviation of the positions of the individual electrode sheets from each other, must therefore be maintained within narrow limits.

An established method for determining the deposition accuracy is computer tomography (CT). A three-dimensional image of a stack is generated by means of a lengthy measurement.

In contrast to CT, there are also test devices that enable a two-dimensional image of the stack or the test object using X-rays. In contrast to computer tomography, these are able to carry out tests more quickly. However, direct measurement of the position of the electrode sheets relative to each other is not yet possible in this way. Due to the use of X-rays, both methods can only be used with high investment, operating and maintenance costs. Furthermore, comprehensive radiation protection must be implemented, meaning that the methods are only suitable for use in a production line to a limited extent. In addition, testing with CT is not inline-capable due to the long measuring times.

Furthermore, the positions of the electrode sheets can already be recorded during the stacking process of the individual electrode sheets. This has the following disadvantages: Cycle time reduction of the stacking process, high data volumes, final position in the tensioned stack unknown.

US 2013/0048340 A1 discloses an electrode for a battery cell and a method for manufacturing the electrode. Optical detection of an edge of the active material arranged on a carrier material is also proposed. The different reflection of light is used to detect the position of the edge.

US 2013/0320216 A1 describes a method for detecting foreign particles on electrodes. Light with a wavelength of 4 μm to 10 mm is used.

A method for producing electrodes is known from U.S. Pat. No. 6,585,846 B1.

### SUMMARY OF THE INVENTION

It is therefore an object of the present invention to solve at least some of the problems mentioned. In particular, a method for determining the deposition accuracy of a plurality of electrode sheets in a stack is to be proposed. Furthermore, a measuring device for determining the deposition accuracy is to be proposed.

In an example, a method is provided for determining a deposition accuracy of a plurality of electrode sheets is proposed. The electrode sheets each comprise at least one anode sheet (or a plurality of anode sheets), one cathode sheet (or a plurality of cathode sheets) and one separator sheet (or a plurality of separator sheets). The electrode sheets extend in planes (substantially) parallel to each other and are arranged stacked on top of each other. The electrode sheets form a stack. The deposition accuracy describes a respective position of at least boundary edges of the anode sheet, the cathode sheet or the separator sheet in the stack. The method is performed with a measuring device comprising at least a camera and a light source. The method may comprise at least the following steps: (a) providing the stack and arranging the stack in the measuring device; wherein a connecting straight line between the light source and the camera is substantially parallel to the planes; (b) illuminating the stack with the light source so that light beams pass through at least a region of the stack or are reflected from the region, wherein the light beams are being detected by the camera; (c) capturing an image (or multiple images) of at least the region of the stack with the camera; and (d) evaluating the image (or the plurality of images) and determining the position of the boundary edges arranged in the region of at least the anode sheet, the cathode sheet or the separator sheet.

The above (non-exhaustive) classification of the process steps into a) to d) is intended primarily only for differentiation and is not intended to enforce any sequence and/or dependency. The frequency of the process steps, e.g. during the execution of the process, may also vary. It is also possible for process steps to at least partially overlap in time. Process step a) is particularly preferred to take place before steps b) to d). In particular, steps b) and c) take place at least partially parallel to each other. In particular, step d) takes place after step d). In particular, steps a) to d) are carried out in the specified sequence.

The method is used, for example, as part of a manufacturing process for battery cells. Electrode sheets cut to a suitable shape, i.e. the at least one anode sheet, the at least one cathode sheet and/or the at least one separator sheet, are arranged in a predetermined sequence to form a stack and aligned with one another. In the stack produced in this way, the boundary edges of the individual (identical) electrode sheets should be arranged in as aligned a position as possible relative to one another.

In particular, the electrode sheets extend in planes parallel to each other and, when stacked on top of each other, form a stack. In particular, the stack comprises at least two electrode sheets, i.e. at least one anode sheet/cathode sheet and one separator sheet. Preferably, the stack comprises at least one anode sheet, at least one cathode sheet and a separator sheet arranged between them.

In particular, the electrode sheets each have a substantially rectangular shape. If necessary, arrester tabs extend beyond this rectangular shape. These are generally uncoated, i.e. not coated with the active material, and are used for the electrical contacting of the respective electrode sheet, i.e. the anode or cathode sheet.

The deposition accuracy describes, for example, a respective position of at least the boundary edges of the anode sheet, the cathode sheet and/or the separator sheet or the anode sheets, the cathode sheets or the separator sheets in the stack. In particular, the electrode sheets should be arranged in a predetermined position relative to each other. Since the size of anode sheets and cathode sheets as well as any separator sheets present may differ from one another, the deposition accuracy is determined at the boundary edges of the electrode sheets, which are arranged in alignment with one another along a direction extending transversely to the planes.

In particular, the deposition accuracy of the electrode sheets is only determined at one boundary edge or at one point of an electrode sheet.

The method can be carried out, for example, with a measuring device that can have at least one camera and one light source. Several fixed or movable light sources can be provided. Several fixed or movable cameras can also be provided. In particular, each light source is only assigned to one camera, but several light sources can be assigned to one camera.

A light source can be used to emit light radiation, which can comprise at least visible light. A camera can be used to record the light radiation in order to display an image. In particular, a camera comprises at least one lens (e.g. telecentric) and a sensor that converts the incident light into an electrical signal.

In particular, the camera makes it possible to display a two-dimensional image of the region of the stack exposed to the light beams from the light source.

According to step a), the stack is provided and can be arranged in the measuring device between the light source and the camera or in such a way that the light beams are reflected from the stack towards the camera; wherein a connecting straight line between the light source and the camera (which passes through the stack or runs at a distance from it) runs essentially parallel to the planes. It is possible that the stack is formed separately and then arranged as a whole in the measuring device. However, it is also possible that the stack itself is (partially) formed in the measuring device and thus arranged simultaneously. In particular, the light source is aligned towards the camera so that the light beams are emitted from the light source towards the camera. The light source and the camera may also be directed towards the (same) region of the stack so that the light beams reflected by the stack are detected by the camera. The light source and the camera are aligned with the stack in such a way that the light beams (if they were directed and thus parallel to each other, emerging from the light source and running along the connecting straight line towards the camera) run parallel to the planes.

According to step b), the stack is illuminated with the light source so that light beams pass through at least one region of the stack or are reflected from the stack towards the camera. The light beams are captured by the camera. The stack is therefore at least partially illuminated. Only the light beams from the light source that pass through the stack, e.g. through free spaces between the electrode sheets, can be detected by the camera.

The light beams from the light source capture the superimposed boundary edges of the electrode sheets so that a two-dimensional image of the boundary edges of the stack can be captured and recorded by the camera.

According to step c), an image of at least the region of the stack is captured by the camera. In particular, only one image of the region of a stack is captured. In particular, further images of the region are not required. If necessary, a further image of another region (formed by other side surfaces) can be recorded and evaluated.) A different arrangement of light source and camera is also possible for capturing the boundary edges of the separator sheets, which are regularly larger than the anode and cathode sheets. In this case, the light beams could also run transversely or at an angle (i.e. not parallel) to the planes.

According to step d), the image is evaluated and the position of the boundary edges of the anode sheet, the cathode sheet and/or the separator sheet arranged in the region is determined. In particular, the evaluation can be carried out by a data processing system. In particular, only one image is evaluated for a stack, possibly a further image that was generated by recording another region.

In particular, the procedure is carried out several times so that the deposition accuracy of the individual electrode sheets is determined with sufficient accuracy. In particular, several different regions of the stack must be illuminated and recorded by the camera and corresponding images generated and evaluated. In particular, this allows the rotation or translation of each electrode sheet relative to a target position to be determined.

In order to check and determine the deposition accuracy of the entire stack, at least three different regions, e.g. edges of the stack, are recorded with the measuring device.

For example, at certain edges of the stack (i.e. a cuboid stack-arresters are not considered-the four shortest edges), an image can be generated once from both directions in order to determine the spatial coordinates of the edge via triangulation. In particular, the stack is rotated and turned relative to the camera and the light source by a holding device. Each of the edges described above is therefore captured by the camera from two directions. In particular, eight images are generated for each stack.

The measuring device can comprise a system for data processing which, includes, for example, a computer, a programmable logic controller, etc. which is suitably equipped, configured or programmed to carry out the method or which carry out the method. The system can comprise, for example, a processor and a memory in which instructions to be executed by the processor are stored, as well as data lines or transmission devices which enable the transmission of instructions, measured values, data or the like between the aforementioned elements.

In particular, the stack has a plurality of side surfaces formed by the plurality of electrode sheets. In step a), the stack is arranged between the light source and the camera such that the connecting straight line passes through a first side surface and a second side surface which are arranged at a smallest angle of less than 180 angular degrees to each another, for example less than 150 angular degrees, preferably less than 120 angular degrees. In particular, the smallest angle between the side surfaces is at least 70 angular degrees, preferably at least 80 angular degrees.

In particular, the side surfaces are therefore not arranged parallel to each other or opposite each other.

The side surfaces of the stack considered here can be formed, for example, by the boundary edges of the electrode sheets, especially the separator sheets, as these regularly have a greater extension than the anode sheets and cathode sheets in order to avoid short circuits. These side surfaces extend transversely to the planes along which the electrode sheets extend.

The first side surface and the second side surface can be arranged adjacent to each other.

The region can comprise an edge of the stack formed by the adjacent side surfaces.

The connecting straight line can extend at a smallest second angle of less than 90 angular degrees, for example of less than 75 angular degrees, preferably of less than 60 angular degrees, to the first side surface and to the second side surface. A smallest second angle between the respective side surface and the connecting straight line can be at least 25 angular degrees, preferably at least 40 angular degrees.

In step d) at least the positions of the boundary edges of the at least one anode sheet and of the at least one cathode sheet can be determined. Thus, it is not necessary to determine the boundary edges of the separator sheets because the electrode sheets are regularly larger than the anode sheets and the cathode sheets. As explained above, the boundary edges of the separator leaves can also be determined using a different arrangement of light source and camera.

Determining the boundary edges of the at least one anode sheet and the at least one cathode sheet may be necessary because the electrochemical performance of a battery cell decreases more quickly during operation with less electrode coverage or coverage of the active material.

The light source can generates visible light, preferably at least with a wavelength between 365 and 870 nm [nanometers].

The light beams can be coherent and/or collimated (i.e. aligned parallel to each other). The light beams may be diffuse and/or coherent. For example, the light that runs essentially parallel to the planes can be used primarily. This can improve the accuracy of the image and simplify evaluation. The accuracy can be further improved by using coherent or collimated light.

The measuring device can comprise a nozzle through which a gas flow can be applied to the region at least during steps b) and c). In particular, the nozzle is positioned in such a way that the electrode sheets are fanned out or aligned by the gas flow. This can improve the passage of the light beams through the electrode sheets.

The gas flow can be ionized so that an electrostatic charge on the electrode sheets, especially between the separator sheets and the anode or cathode sheets, can be dissolved. This can further improve the passage of light beams through the electrode sheets.

Also, artificial intelligence can be used, for example, at least for step d). Artificial intelligence can be used to support the determination of the positions of the boundary edges in the image.

The at least one image can be evaluated using a convolutional neural network (CNN). The convolutional neural network learns from a synthetic, i.e. artificially generated, data set of a stack with known positions of the boundary edges of the electrode sheets in order to then determine the position of the boundary edge of a (desired) electrode sheet from the image of this stack captured in accordance with step c). If, for example, an electrode sheet sags, i.e. does not run ideally in a horizontal plane, the correct position of the boundary edge can be calculated using a polynomial.

Instead of using a convolutional neural network, the evaluation can also be carried out using another machine or automatedly workable learning method. In the following, the focus is on the convolutional neural network and the processes and terms used.

The use of such CNNs for the evaluation of images, i.e. camera images, is generally known. In the present case, the use of CNN is proposed for the quality evaluation of (cut) boundary edges of the electrode sheets, i.e. in the context of manufacturing battery components.

As part of the evaluation with CNN, in order to implement an automated and inline-capable evaluation of the boundary edges, a training data set, i.e. the synthetic data set, can be generated first. The positions of the boundary edges can be marked manually on each image of this training data set. This manual marking, i.e. the marked position of the boundary edges, is then exported manually from the tool. The positions of the boundary edges in the image, coded as a pixel matrix, represent the stack geometry or arrangement of the boundary edges for the training data set, the so-called ground truth.

In the following, a CNN is used to learn a mathematical mapping of the boundary edge shown in the figure to its corresponding geometry. The CNN trained in this way can then recognize the boundary edges or geometry for previously unlearned images of the camera. Due to the low variance of the different images of essentially similar bodies, in this case boundary edges of stacked electrode sheets with a defined target geometry of the boundary edges, and the statistical significance of large amounts of data, this recognition is more accurate than comparable methods, e.g. trend edge recognition.

As is well known, the CNN formed of a series of so-called convolutional layers that discretely convolve a fixed number of filters with image sections. For each of its filters, this layer calculates a so-called feature map. This feature map describes whether a pattern, defined by the filter parameters, was recognized at the corresponding position in the respective second image or in the contour. The size of these feature maps is reduced with the help of so-called max-pooling layers or average-pooling layers in order to reduce the complexity of the calculation. The max-pooling or average-pooling layer pushes an n×n window over the feature map and may only transfers the maximum value from one section to the next layer.

The order and number of convolutional and max-pooling or average-pooling layers as well as the size of the respective windows and filters are so-called hyper-parameters. These hyper-parameters are optimized, for example, by a validation dataset, which has no influence on the optimization of model parameters.

In the final step, the values of all feature maps are concatenated to form a vector, known as flattening, and thus serve as input to a feed-forward neural network. This network is in turn characterized by a variable number of hidden layers and a variable number of neurons in the respective hidden layers. These numbers form further hyper-parameters.

As an alternative to flattening, transposed convolution can be used to first transform the condensed feature maps back to their original size and then reduce their number back to one using convolutional layers.

In its output layer, the network attempts to approximate the manually generated edge geometry of the ground truth of the stack by assigning a zero or a one (“1”) to each pixel.

At the beginning of the training, the filter parameters and the parameters of the feed-forward neural network (both together form the CNN) can be initialized randomly, which initially leads to an inaccurate geometry prediction. During training, all model parameters are adjusted using a so-called gradient descent method so that the number of incorrectly classified pixels is minimized across all training examples.

After training, the CNN can be used, for example, to recognize the position of at least one boundary edge in the image for unknown stacks or newly created images as part of step d).

Also, at least one process parameter used for the production of the respective stack can be determined and changed from the evaluation of the deposition accuracy according to step d), so that a deposition accuracy for further stacks is improved.

The incorrectly positioned electrode sheet and its deviation from the target position can be determined if, for example, a limit value has been exceeded and/or validated in the course of subsequent measurements. Accordingly, the manufacturing process of the electrode sheet can be traced from the knowledge of the electrode sheet and, if necessary, adjustable process parameters can be changed.

A measuring device for carrying out the method described is also proposed, comprising at least a camera and a light source. A stack of stacked electrode sheets, which extend in mutually parallel planes, can be arranged relative to the camera and the light source in such a way that a connecting straight line between the light source and the camera runs essentially parallel to the planes. In particular, the light source is aligned towards the camera and the stack is arranged between the light source and the camera so that the light beams pass through at least one region of the stack. The light source and the camera can be aligned with a (same) region of the stack, whereby the light beams are reflected by the region and captured by the camera.

The measuring device can comprise at least two cameras and two light sources, wherein the stack has a plurality of side surfaces formed by the plurality of electrode sheets. The cameras and light sources are arranged such that a first connecting straight line between a first camera and a first light source passes through a first side surface and a second side surface of the stack, which are arranged at a smallest first angle of less than 180 angular degrees to each other, and in that a second connecting straight line between a second camera and a second light source passes through a third side surface and a fourth side surface of the stack, which are arranged relative to one another at a smallest first angle of less than 180 angular degrees to each, for example, less than 150 angular degrees, preferably less than 120 angular degrees. In particular, a smallest first angle between the side surfaces is at least 70 angular degrees, preferably at least 80 degrees.

The measuring device can comprise three or even four cameras and a comparable number of light sources or a number adapted to the requirements. This can further accelerate the determination of the deposition accuracy of all electrode sheets, as images of different or identical areas (possibly taken from other directions) can be generated and evaluated simultaneously.

A system for data processing is proposed which has components, i.e. a processor, a memory, a display, user input and output devices, which are suitably equipped, configured or programmed to carry out the method or which carry out the method.

The components comprise, for example, a processor and a memory in which instructions to be executed by the processor are stored, as well as data lines or transmission devices which enable the transmission of instructions, measured values, data or the like between the aforementioned elements.

There is further proposed a computer program comprising instructions which, when the program is executed by a computer, cause the computer to carry out the described method or the steps of the described method.

A computer-readable storage medium is further proposed, comprising instructions which, when executed by a computer, cause the computer to carry out the described method or the steps of the described method.

The examples of the method apply to the data processing system and/or the computer-implemented method (i.e. the computer program and the computer-readable storage medium) and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a stack in a holding device, in a perspective view;

FIG. 2 shows a side view of the stack according to FIG. 1;

FIG. 3 shows an image of a stack and a measuring device with a stack arranged therein, with which the image can be produced;

FIG. 4 shows another measuring device with a stack arranged therein, in a top view; and

FIG. 5: shows another measuring device with a stack arranged therein, in a plan view.

### DETAILED DESCRIPTION

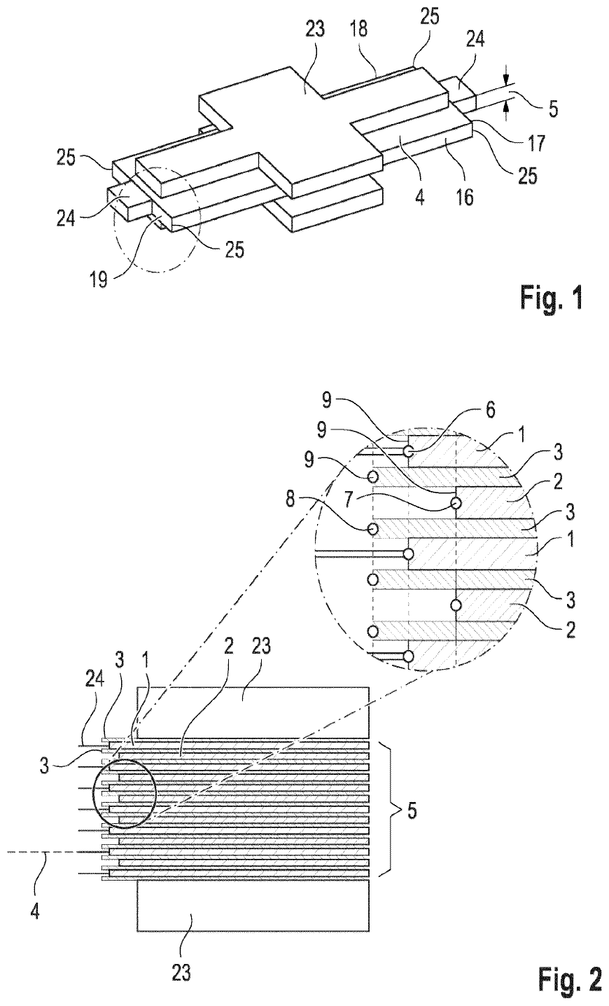

FIG. 1 shows a stack 5 in a holding device 23, in a perspective view. FIG. 2 shows the stack 5 according to FIG. 1 in a side view. FIGS. 1 and 2 are described together below.

The electrode sheets 1, 2, 3 comprise anode sheets 1, cathode sheets 2 and separator sheets 3. The electrode sheets 1, 2, 3 extend in mutually parallel planes 4 and are arranged stacked on top of one another. The electrode sheets 1, 2, 3 form a stack. The deposition accuracy describes a respective position 6, 7, 8 of boundary edges 9 of the anode sheets 1, the cathode sheets 2 or the separator sheets 3 in the stack 5. The electrode sheets 1, 2, 3 extend in mutually parallel planes 4 and form the stack 5 when stacked on top of one another.

The electrode sheets 1, 2, 3 each have a substantially rectangular shape. The stack 5 has several side surfaces 16, 17, 18, 19, which are formed by the plurality of electrode sheets 1, 2, 3. The side surfaces 16, 17, 18, 19 of the stack 5 are formed by the boundary edges 9 of the electrode sheets 1, 2, 3, in this case the separator sheets 3, as these regularly have a greater extension than the anode sheets 1 and cathode sheets 2 in order to avoid short circuits. The side surfaces 16, 17, 18, 19 extend transversely to the planes 4 along which the electrode sheets 1, 2, 3 extend.

Arrester (flags) 24 extend beyond this rectangular shape of the electrode sheets 1, 2, 3. These arresters 24 are generally uncoated, i.e. not coated with the active material, and are used for the electrical contacting of the respective electrode sheet 1, 2, i.e. the anode sheet 1 or the cathode sheet 2.

FIG. 2 shows a detailed view of how the boundary edges 9 of the electrode sheets 1, 2, 3 are arranged in a nominal arrangement. The electrode sheets 1, 2, 3 are arranged alternately along the stacking direction (running transverse to the planes 4). The second positions 7 of the cathode sheets 2 are arranged furthest inwards, i.e. at the greatest distance from the first side surface 16. The first positions 6 of the anode sheets 1 are located between the second positions 7 and the third positions 8 of the separator sheets 3. The first side surfaces 16 of the stack 5 are formed by the boundary edges 9 of the separator sheets 3.

The holding device 23 here comprises two plates, between which the stack 5 is arranged. The electrode sheets 1, 2, 3 are held or fixed in their positions 6, 7, 8 via the holding device 23 and the stack 5 can thus be arranged in the measuring device 10.

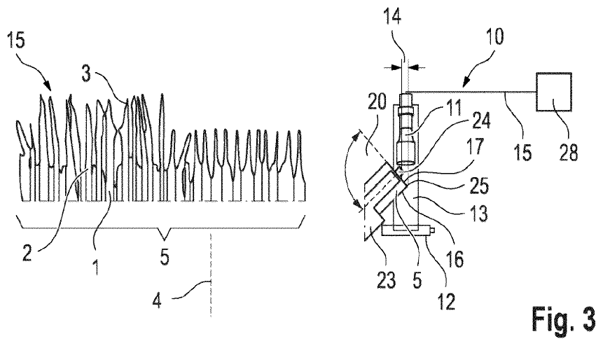

FIG. 3 shows an image of a stack 5 (left) and a measuring device 10 with a stack 5 arranged therein (right), with which the image 15 can be produced. Reference is made to the comments on FIGS. 1 and 2.

The measuring device 10 has a camera 11 and a light source 12. In step a), the stack 5 is arranged between the light source 12 and the camera 11 in such a way that the connecting straight line 27 (here running parallel to the collimated light beams 13) runs through a first side surface 16 and a second side surface 17, which are arranged at a smallest first angle 20 of 90 angular degrees to each other and are adjacent to each other.

According to step b), the stack 5 is illuminated with the light source 12 so that light beams 13 pass through a region 14 of the stack 5 and are detected by the camera 11. The region 14 comprises an edge 25 of the stack 5 formed by the adjoining side surfaces 16, 17.

The connecting straight line 27 runs at a smallest second angle 26 of approximately 45 angular degrees to the first side surface 16 and to the second side surface 17.

The stack 5 is therefore at least partially illuminated. Only the light beams 13 of the light source 12 that pass through the stack 5, e.g. through free spaces between the electrode sheets 1, 2, 3, can be detected by the camera 11.

The light beams 13 of the light source 12 capture the superimposed boundary edges 9 of the electrode sheets 1, 2, 3, so that a two-dimensional image 15 of the boundary edges 9 of the stack 5 can be captured and recorded by the camera 11.

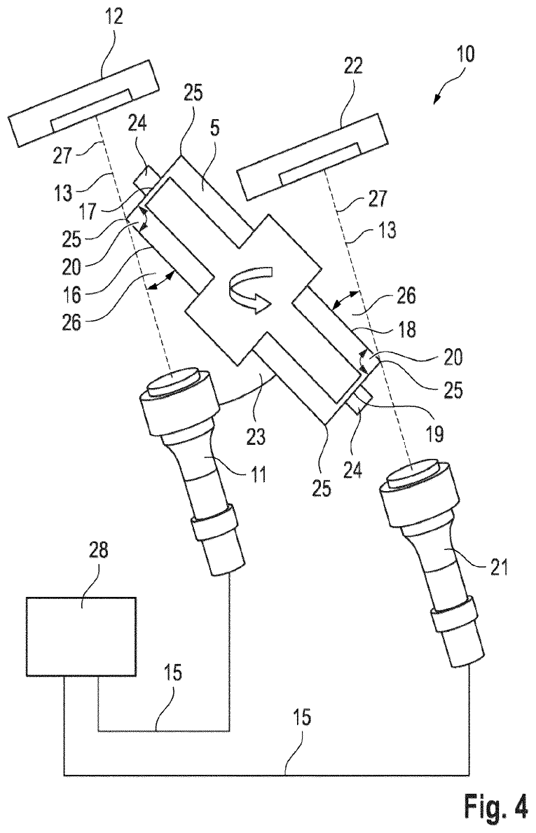

According to step c), an image 15 of at least the region 14 of the stack 5 is captured by the camera 11. An image 15 of the region 14 of a stack 5 is captured. Further images of the region 14 or other regions 14 may be required to determine the deposition accuracy and can be generated by changing the position of the stack 5 or by changing the position of the camera 11 or light source 12. Further images 15 of at least one other region 14 (formed by other side surfaces 18, 19; see FIG. 4) can thus be recorded and evaluated.

According to step d), the image 15 is evaluated and the position 6, 7, 8 of the boundary edges 9 arranged in the region 14 of at least the anode sheets 1 and the cathode sheets 2 is determined. The evaluation is carried out by a system 28 for data processing.

FIG. 4 shows a further measuring device 10 with a stack 5 arranged therein, in a top view. Reference is made to the comments on FIGS. 1 to 3.

The electrode sheets 1, 2, 3 each have an essentially rectangular shape. The stack 5 has several side surfaces 16, 17, 18, 19, which are formed by the plurality of electrode sheets 1, 2, 3. The side surfaces 16, 17, 18, 19 of the stack 5 are formed by the boundary edges 9 of the electrode sheets 1, 2, 3, in this case the separator sheets 3. The side surfaces 16, 17 18, 19 extend transversely to the planes 4 along which the electrode sheets 1, 2, 3 extend. Arrester (flags) 24 extend beyond this rectangular shape of the electrode sheets 1, 2, 3. The stack 5 is arranged in a holding device 23.

The measuring device 10 comprises a first camera 11 and a first light source 12 as well as a second camera 21 and a second light source 22. In step a), the stack 5 is arranged between the first light source 12 and the first camera 11 and simultaneously between the second light source 22 and the second camera 21 in such a way that the respective connecting straight line 27 runs through a first side surface 16 and a second side surface 17 or through a third side surface 18 and a fourth side surface 19.

The first side surface 16 and the second side surface 17 are arranged at a smallest first angle 20 of 90 angular degrees to each other and are adjacent to each other. According to step b), the stack 5 is illuminated with the first light source 12 so that light beams 13 pass through a region 14 of the stack 5 and are captured by the first camera 11. The region 14 comprises an edge 25 of the stack 5 formed by the adjoining side surfaces 16, 17. The connecting straight line 27 extends at a second angle 26 of approximately 30 angular degrees to the first side surface 16 and at a smallest second angle 26 of approximately 60 angular degrees to the second side surface 17.

The third side surface 18 and the fourth side surface 19 are arranged at a smallest first angle 20 of 90 angular degrees to each other and are adjacent to each other. According to step b), the stack 5 is (also) illuminated with the second light source 22, so that light beams 13 pass through a further region 14 of the stack 5 and are detected by the second camera 21. The region 14 comprises an edge 25 of the stack 5 formed by the adjoining side surfaces 18, 19. The connecting straight line 27 extends at a smallest second angle 26 of approximately 30 angular degrees to the third side surface 18 and at a smallest second angle 26 of approximately 60 angular degrees to the fourth side surface 19.

According to step c), the images 15 of the two regions 14 of the stack 5 are recorded with the respective camera 11, 21. Only the two images 15 of the two regions 14 of the stack 5 are recorded. Further images of regions 14 can be generated successively or simultaneously to determine the deposition accuracy.

According to step d), the images 15 are evaluated and the position 6, 7, 8 of the boundary edges 9 arranged in the respective region 14 of at least the anode sheets 1 and the cathode sheets 2 is determined. The evaluation is carried out by a system 28 for data processing.

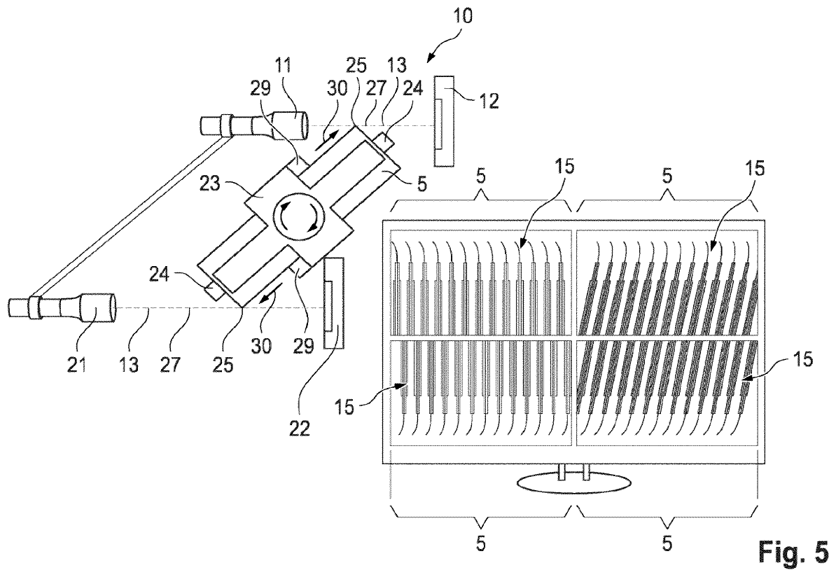

FIG. 5 shows in a top view of another measuring device 10 with a stack 5 arranged therein. Reference is made to the comments on FIGS. 1 to 4 and in particular FIGS. 3 and 4.

The measuring device 10 comprises two nozzles 29, through which the respective region 14 can be supplied with a gas flow 30 at least during steps b) and c). The nozzle 29 is positioned in such a way that the electrode sheets 1, 2, 3 are fanned out or aligned by the gas flow 30 (see detail at bottom right in FIG. 5). This can improve the passage of the light beams 13 through the electrode blades 1, 2, 3.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for determining a deposition accuracy of at least two electrode sheets, each of the at least two electrode sheets comprising at least one anode sheet, a cathode sheet and a separator sheet, wherein the at least two electrode sheets extend in mutually parallel planes and are arranged stacked on top of each other to form a stack, the deposition accuracy representing a respective position of at least boundary edges of the anode sheet, the cathode sheet or the separator sheet in the stack, the method being performed with a measuring device having at least a camera and a light source, the method comprising:
providing the stack and arranging the stack in the measuring device, wherein a connecting straight line between the light source and the camera is substantially parallel to the planes;
illuminating the stack with the light source so that light passes through at least a region of the stack or is reflected from the region, the light being detected by the camera;
capturing an image of at least the region of the stack with the camera; and
evaluating the image and determining the position of the boundary edges arranged in the region of at least the anode sheet, the cathode sheet or the separator sheet.

2. The method according to claim 1, wherein the stack has a plurality of side surfaces formed by the at least two electrode sheets, wherein the stack is arranged between the light source and the camera such that the connecting straight line passes through a first side surface and a second side surface that are arranged at a smallest first angle of less than 180 angular degrees to each other.

3. The method according to claim 2, wherein the first side surface and the second side surface are arranged adjacent to each other.

4. The method according to claim 3, wherein the region comprises an edge of the stack formed by the adjacent side surfaces.

5. The method according to claim 1, wherein at least the positions of the boundary edges of the anode sheet and the cathode sheet are determined.

6. The method according to claim 1, wherein the light source generates visible light.

7. The method according to claim 1, wherein the light is at least coherent or collimated and runs substantially parallel to the planes.

8. The method according to claim 1, wherein artificial intelligence is used at least for evaluating the image.

9. A measuring device to perform the method according to claim 1, the measuring device comprising:
a first camera; and
a first light source,
wherein a stack of electrode sheets, which extend in mutually parallel planes, are arranged relative to the camera and the light source such that a connecting straight line between the light source and the camera runs essentially parallel to the planes.

10. The measuring device according to claim 9, further comprising:
a second cameras; and
a second light source,
wherein the stack has a plurality of side surfaces formed by the plurality of electrode sheets,
wherein the first camera and the first light source are arranged such that a first connecting straight line between the first camera and the first light source passes through a first side surface and a second side surface of the stack, which are arranged at a first angle of less than 180 angular degrees to each other, and
wherein the second camera and the second light source are arranged such that a second connecting straight line between the second camera and the second light source passes through a third side surface and a fourth side surface of the stack, which are arranged relative to one another at a second angle of less than 180 angular degrees.
